(19) United States
(12) Patent Application Publication
(10) Pub. No.: US 2014/0104493 A1
(43) Pub. Date: Apr. 17, 2014

(54) PROACTIVE VIDEO FRAME DROPPING FOR HARDWARE AND NETWORK VARIANCE

(71) Applicants: Yuxin Liu, Cupertino, CA (US); Haim Vaisburd, Redwood City, CA (US); Yixin Yang, Beijing (CN); Shaowei Su, Beijing (CN); Xu Liu, San Jose, CA (US)

(72) Inventors: Yuxin Liu, Cupertino, CA (US); Haim Vaisburd, Redwood City, CA (US); Yixin Yang, Beijing (CN); Shaowei Su, Beijing (CN); Xu Liu, San Jose, CA (US)

(73) Assignee: TANGOME, INC., Palo Alto, CA (US)

(21) Appl. No.: 13/649,863

(22) Filed: Oct. 11, 2012

(51) Int. Cl. H04N 7/01

(52) U.S. Cl. 348/441; 348/E07.003

(57) ABSTRACT

A method and system for proactively dropping video frames are disclosed. The method includes: recording, by a computer, a video frame capture timestamp for a video frame that is captured at a first device; associating, by the computer, the video frame capture timestamp to the video frame that is captured; comparing, by the computer, the video frame capture timestamp with a video frame target timestamp for the video frame; and based on the comparing, if a time difference between the video frame capture timestamp and the video frame target timestamp is outside of a predetermined range of time values, then dropping, by the computer, the video frame.

### BACKGROUND

A video frame rate is defined as the number of video frames that are processed per second. In general, it is desired that the video frame rate adapt to various/varying CPU usage and channel bandwidth. Thus, generally, it is desired that a video frame be captured at a determined video frame rate. However, due to the many different existing platforms and varying devices, it is not always possible for a device to accurately and dynamically control the video frame capture rate.

### DESCRIPTION OF EMBODIMENTS

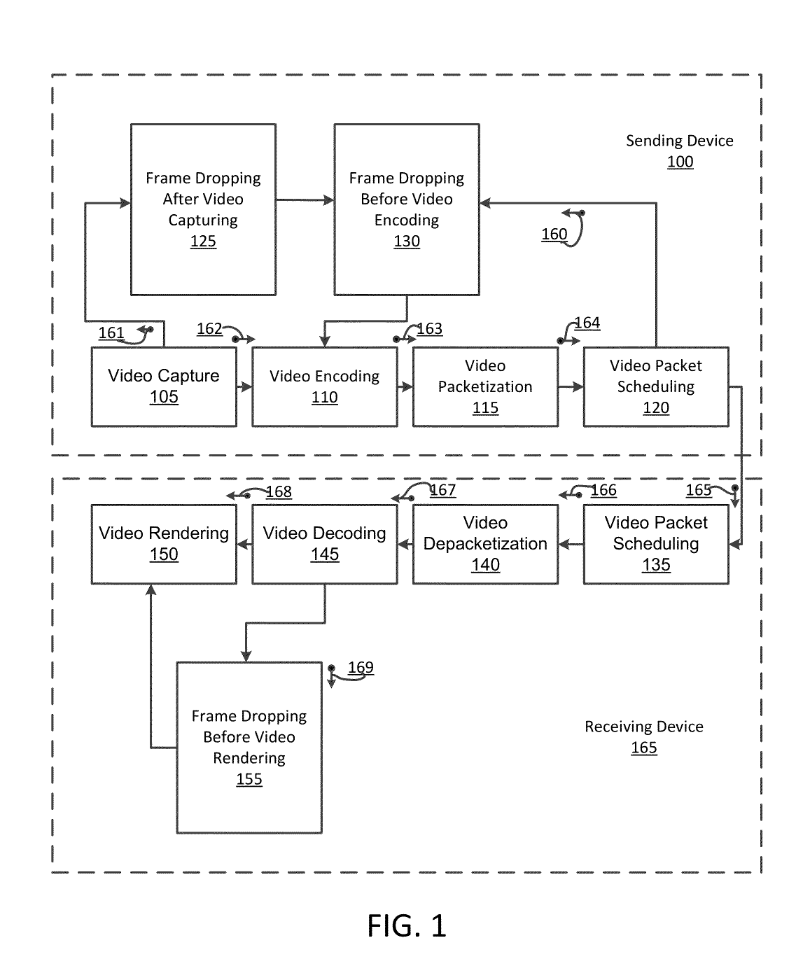

FIG. 1 illustrates an example of frame dropping throughout an entire video call pipeline from a sender to a receiver, in accordance with an embodiment.

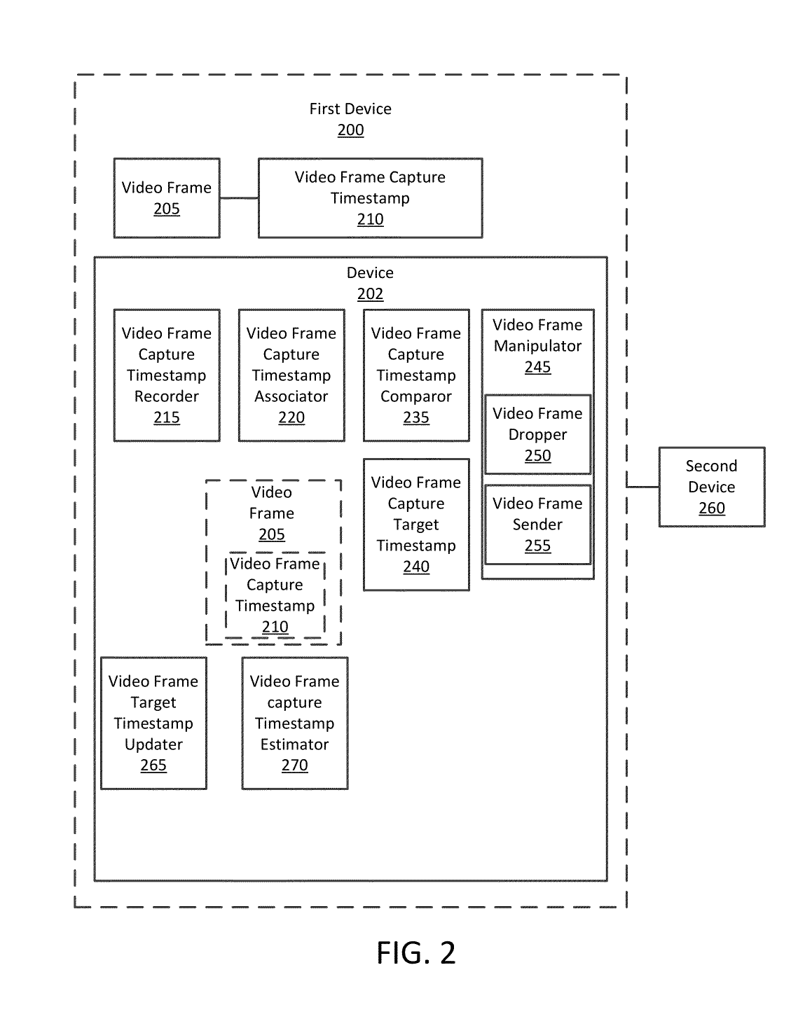

FIG. 2 illustrates a device for proactively dropping video frames, in accordance with an embodiment.

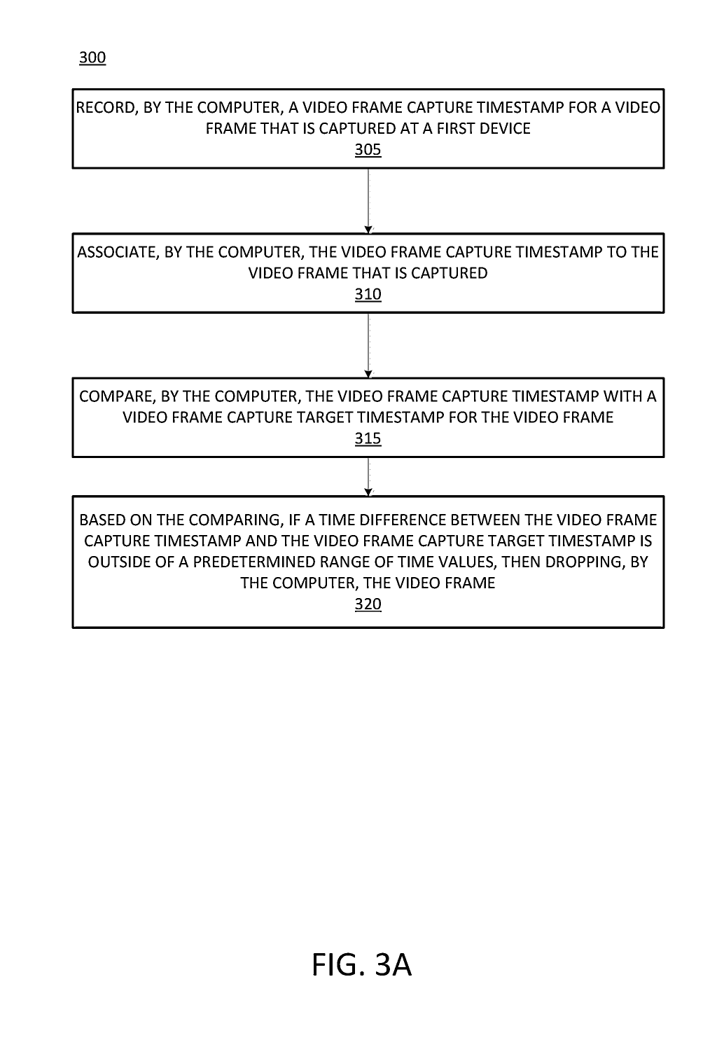

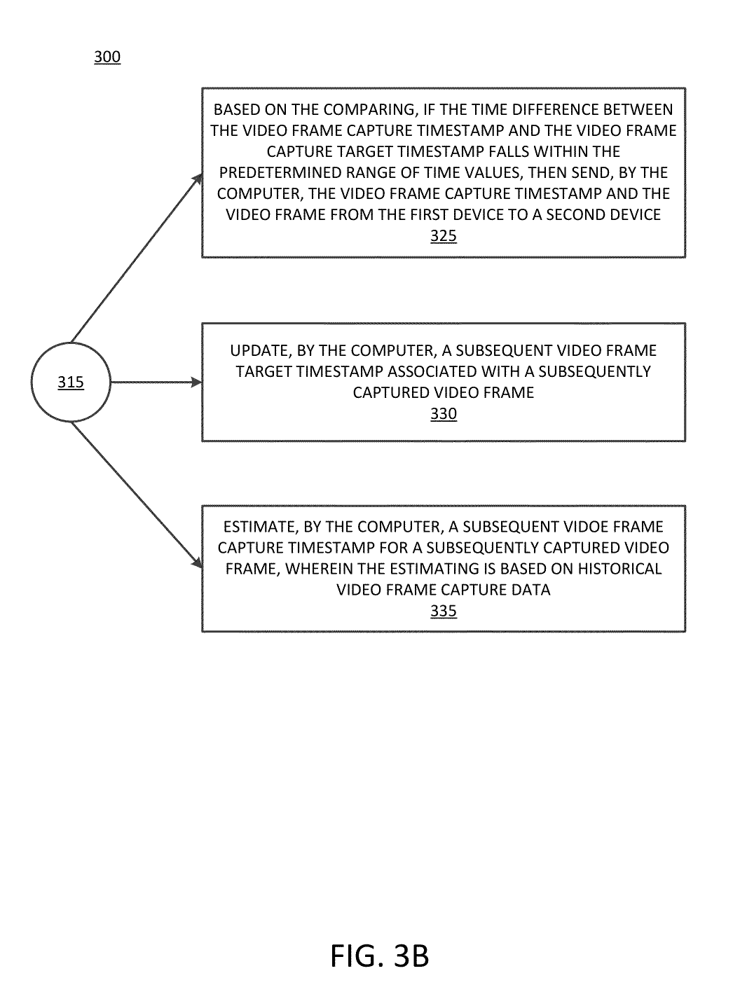

FIGS. 3A and 3B are a flow diagram of a method for proactively dropping video frames, in accordance with an embodiment.

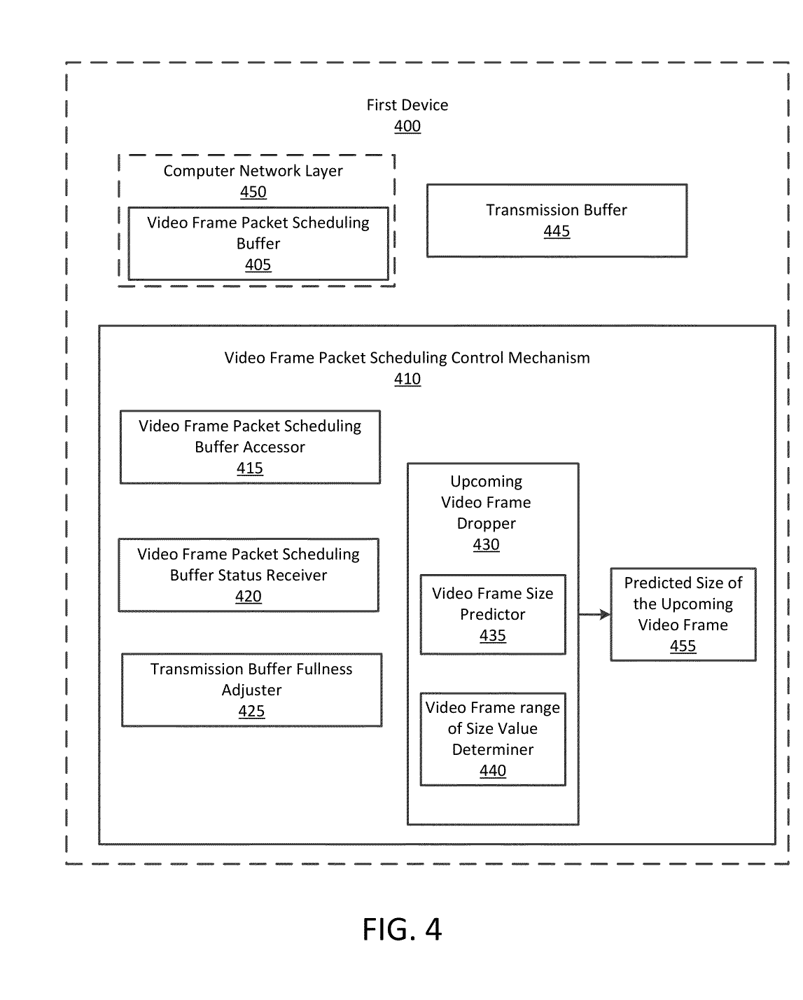

FIG. 4 illustrates a video frame packet scheduling control mechanism for proactively dropping video frames, in accordance with an embodiment.

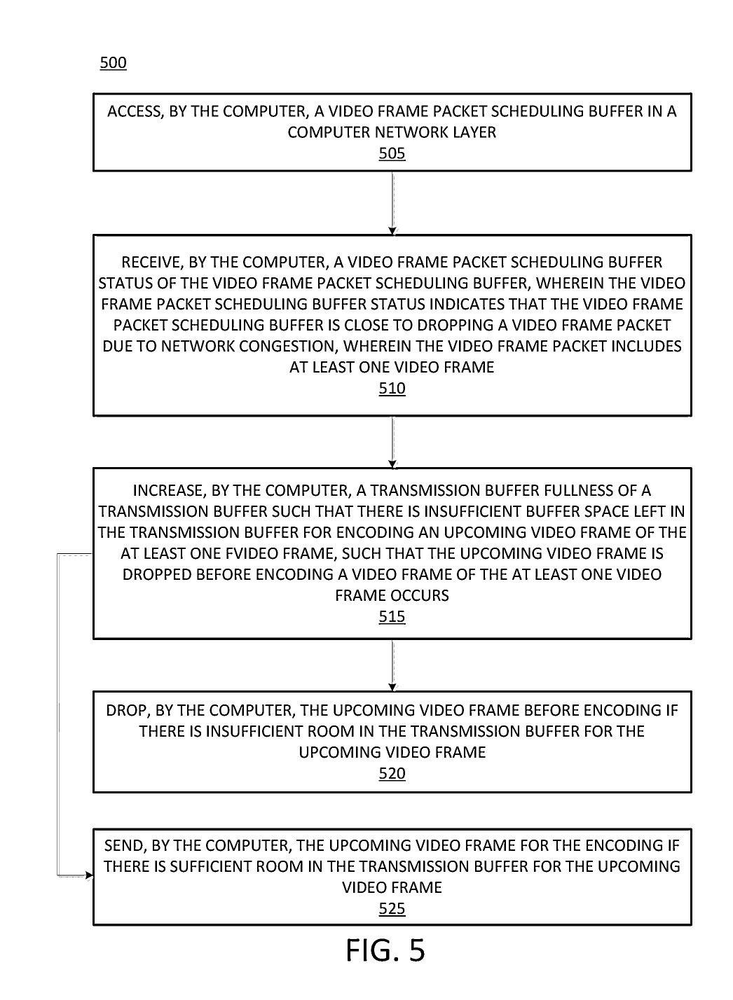

FIG. 5 is a flow diagram of a method for proactively dropping video frames, in accordance with an embodiment.

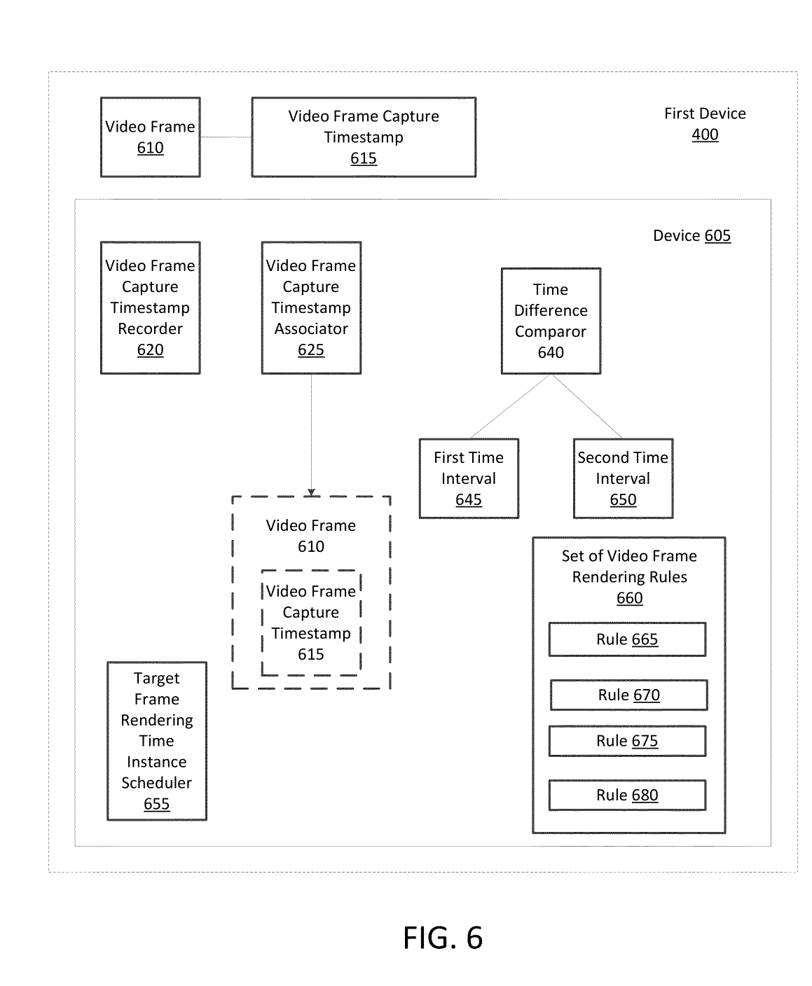

FIG. 6 illustrates a device for proactively dropping video frames, in accordance with an embodiment.

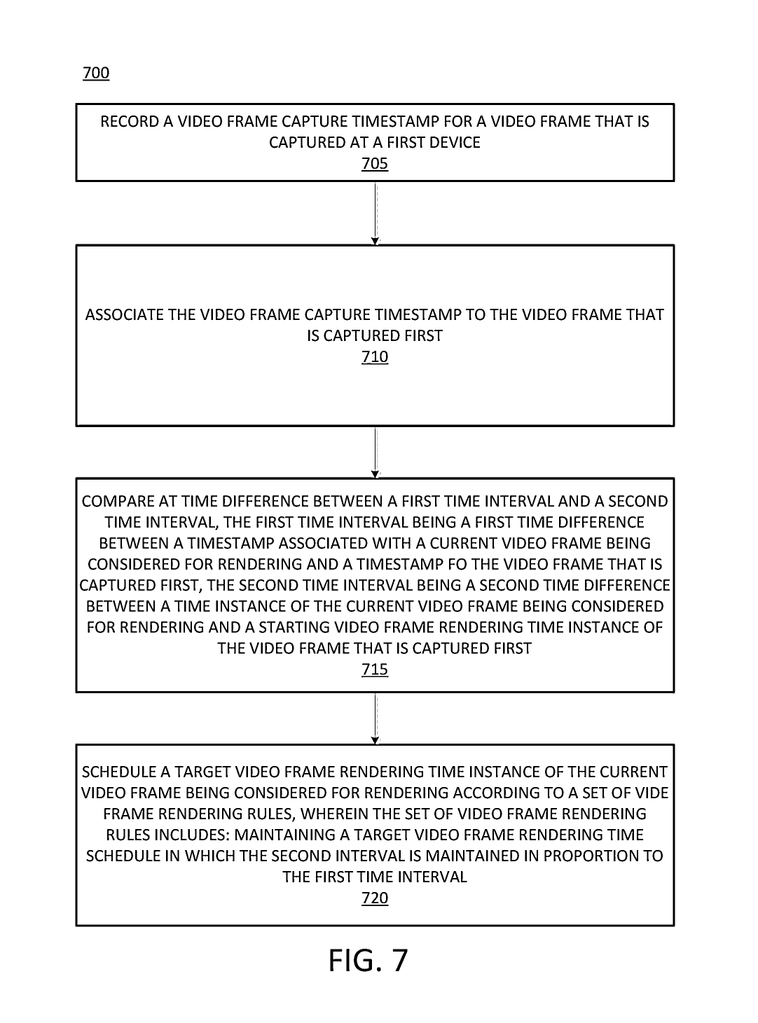

FIG. 7 illustrates a method for proactively dropping video frames, in accordance with an embodiment.

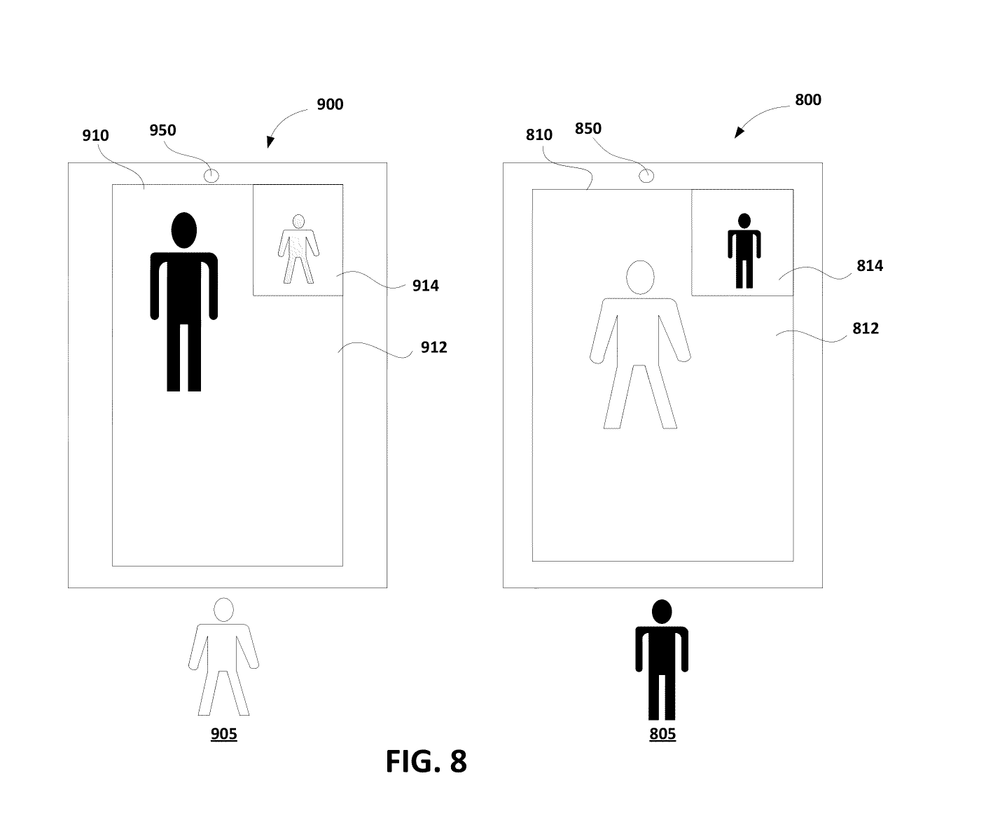

FIG. 8 illustrates example devices upon which embodiments for proactively dropping video frames may be performed, in accordance with embodiments.

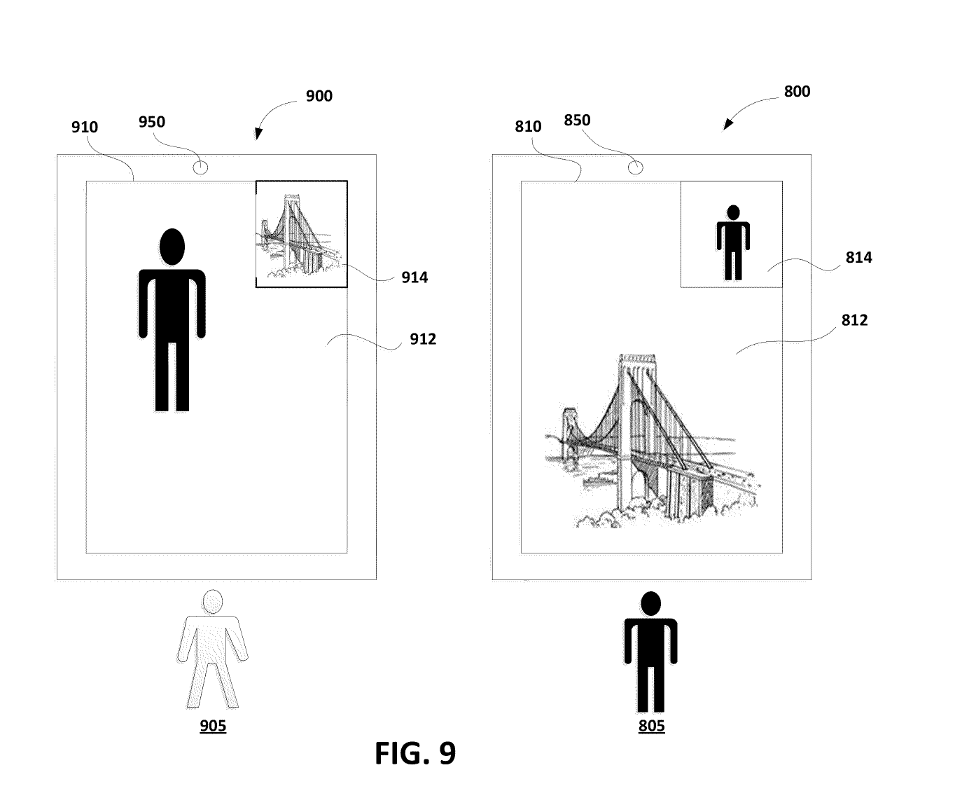

FIG. 9 illustrates example devices upon which embodiments for proactively dropping video frames may be performed, in accordance with embodiments.

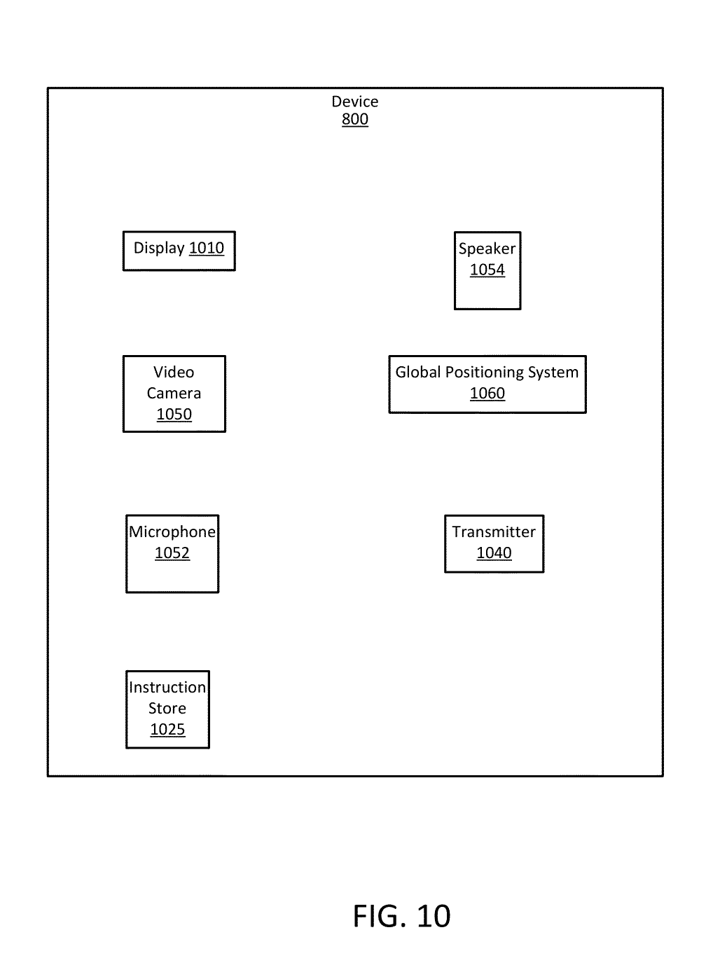

FIG. 10 illustrates a block diagram of an example device (e.g., mobile device) upon which embodiments for proactively dropping video frames may be performed, in accordance with embodiments.

The drawings referred to in this description should be understood as not being drawn to scale except if specifically noted.

### DESCRIPTION OF EMBODIMENTS

Reference will now be made in detail to various embodiments, examples of which are illustrated in the accompanying drawings. While the subject matter will be described in conjunction with these embodiments, it will be understood that they are not intended to limit the subject matter to these embodiments. On the contrary, the subject matter described herein is intended to cover alternatives, modifications and equivalents, which may be included within the spirit and scope. Furthermore, in the following description, numerous specific details are set forth in order to provide a thorough understanding of the subject matter. However, some embodiments may be practiced without these specific details. In other instances, well-known structures and components have not been described in detail as not to unnecessarily obscure aspects of the subject matter.

As will be described below, embodiments proactively drop video frames in various devices (e.g., mobile, desktop) using three different approaches during different phases of a video call pipeline: (1) adaptive video frame dropping after a video frame is captured; (2) adaptive video frame dropping before encoding to facilitate video frame packet scheduling control; and (3) dynamic video frame dropping before video frame rendering. Each approach is described below in more detail.

FIG. 1 illustrates the three possible video frame dropping scenarios occurring throughout an entire video call pipeline from a sender to a receiver. In brief, FIG. 1 shows the processes occurring from a video frame being captured at the sending device 100 to the video frame being rendered at the receiving device 165. As shown, at the sending device 100, the process through which a video frame moves is as follows: video capture 105; video encoding 110; video packetization 115; and video packet scheduling 120. As shown, at the receiving device 165, the process through which a video frame moves is as follows: video packet scheduling 135; video depacketization 140; video decoding 145; and video rendering 150.

In various embodiments, at operation 125, the video frame is dropped after the process of video capture 105. In various embodiments, at operation 130, the video frame is dropped before the video frame encoding 110 begins. Additionally, it is shown, at operation 130, that the video frame scheduling status 160 (that is communicated from the video frame packet scheduling 120 process) is taken into account during the process of video frame dropping before the video frame encoding 110 begins. In various embodiments, at operation 155, the video frame is dropped before video rendering 150. Timestamps 161-169 are also illustrated in FIG. 1. As shown, timestamps are generated upon moving from one process to the next. For example, a video frame is captured at video capture 105. Upon moving to the process of video encoding 110, a timestamp 162 is generated, marking the time at which the encoding of the video frame occurs.

Thus, embodiments provide for the proactive dropping of video frames, instead of waiting for the network to drop the video frame due to various communication problems (e.g., network congestion, insufficient bandwidth, etc.), thereby facilitating a steadily paced communication of video frames between devices.

### Notation and Nomenclature

Reference will now be made in detail to embodiments of the present technology, examples of which are illustrated in the accompanying drawings. While the subject matter will be described in conjunction with various embodiment(s), it will be understood that they are not intended to limit the subject matter to these embodiments. On the contrary, the subject matter described herein is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

Some portions of the description of embodiments which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of an electrical or magnetic signal capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present discussions terms such as “recording”, “associating”, “comparing”, “dropping”, “sending”, “updating”, “estimating”, “accessing”, “receiving”, “increasing”, “predicting”, “keeping”, “sending”, “scheduling”, “maintaining”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

(1) Adaptive Video Frame Dropping after a Video Frame is Captured

A video frame rate is defined as the number of video frames that are processed per second. In general, it is desired that the video frame rate adapt to various/varying CPU usage and channel bandwidth. Thus, generally, it is desired that a video frame be captured at a determined video frame rate. However, due to the many different existing platforms and varying devices, it is not always possible for a device to accurately and dynamically control the video frame capture rate. This is due, in part, to some devices and/or platforms not providing an explicit API that provides for an exact video frame rate, and some devices and/or platforms do not enable a camera frame rate setting to dynamically vary without pausing or blinking occurring during the capturing of the video frame.

Thus, in situations in which the instant target video frame rate is lower than the instant camera capture video frame rate, embodiments provide a method of video frame dropping such that the captured video frames are equally paced while still achieving a varying target video frame rate. In some circumstances, the camera capture video frame rate may vary due to different CPU usage conditions and/or different lighting conditions. Additionally, in other circumstances, the target video frame rate may vary to achieve a good overall end-to-end user experience, such as by adapting to varying network conditions and the local device and/or peer device CPU usage conditions.

The “target time instance” for one video frame is defined as the time instance when the video frame needs to be processed to best achieve the target video frame rate. The “capture time instance” is defined as the time instance when the video frame is being captured. In one embodiment, the target time instance is updated for every newly captured video frame. Using historical data associated with the captured time instances for captured video frames for the video, the capture time instance is estimated for the next captured video frame. When the target time instance for a video frame is close to (meets and/or exceeds a threshold value) a current capture time instance, the newly captured video frame is kept. Otherwise, the newly captured video frame is dropped (skipped).

Embodiments enable the communication of video frames at a steady pace by facilitating the adaptive and proactive dropping of video frames. Want to drop vide frames at capture phase because too many video frames are being captured (video frames are captured too fast). For example, network congestion occurs, and I-frames are lost. Ultimately, losing these I-frames causes the IDR to be translated again, causing more congestion. The capricious dropping of video frames is dangerous because it is not certain what video frames will be lost. Embodiments proactively dropping video frames.

FIG. 2 illustrates a device 202 for proactively dropping video frames. The device 202 includes, as will be described herein, at least the following components coupled with a computer: a video frame capture timestamp recorder 215; a video frame capture timestamp associator 220; a video frame capture timestamp comparor 235; and a video frame manipulator 245 including a video frame dropper 250. In various embodiments, the device 202 optionally includes, as will be described herein, any of the following components coupled with the computer: a video frame sender 255; a video frame target timestamp updater 265; and a video frame capture timestamp estimator 270.

The video frame capture timestamp recorder 215 records a video frame capture timestamp 210 for a video frame 205 that is captured at a first device 200. In various embodiments, the first device 200 is a device that is capable of communicating video to another device (a second device 260). The video frame capture timestamp associator 220 associates the video frame capture timestamp 210 to the video frame 205 that is captured. The video frame capture timestamp comparor 235 compares the video frame capture timestamp 210 with a video frame capture target timestamp 240 for the video frame 205. The video frame capture target timestamp 240 indicates the time at which it is desired that the video frame 210 be captured.

The video frame manipulator 245 manipulates the video frame 210 depending on a time difference between the video frame capture timestamp 210 and the video frame capture target timestamp 240. The video frame manipulator 245 includes a video frame dropper 250. The video frame dropper 250 drops the video frame 205 if the time difference between the video frame capture timestamp 210 and the video frame capture target timestamp 240 is outside of a predetermined range of time values.

The video frame sender 255 sends the video frame capture timestamp 210 and the video frame 205 from the first device 200 to the second device 260 if the time difference between the video frame capture timestamp 210 and the video frame capture target timestamp 240 falls within the predetermined range of time values.

The video frame target timestamp updater 265 updates a subsequent video frame target timestamp associated with a subsequently captured video frame. Thus, every video frame that is captured after the video frame 205 is considered to be a subsequently captured video frame. Every subsequently captured video frame receives a video frame capture timestamp, and is associated with a video frame target timestamp. Every time a new video frame is captured, this video frame capture target timestamp is changed to reflect a new target time at which it is desired that the new video frame have been captured.

The video frame capture timestamp estimator 270 estimates the subsequent video frame capture timestamp described above for a subsequently captured video frame, wherein the estimating is based on historical video frame capture data. The historical video frame capture data may include at least any of the following: all prior video frame capture target timestamps; and all prior video frame capture timestamps.

FIGS. 3A and 3B illustrate a flow diagram of a method for proactively dropping video frames, in accordance with embodiments. At operation 305, in one embodiment and as described herein, a video frame capture timestamp for a video frame that is captured at a first device is recorded. At operation 310, in one embodiment and as described herein, the video frame capture timestamp is associated to the video frame that is captured. At operation 315, in one embodiment and as described herein, the video frame capture timestamp is compared with a video frame capture target timestamp for the video frame. At operation 320, in one embodiment and as described herein, based on the comparing at operation 315, if a time difference between the video frame capture timestamp and the video frame capture target timestamp is outside of a predetermined range of time values, then the video frame is dropped.

With reference now to FIG. 3B, at operation 325, in one embodiment and as described herein, based on the comparing at operation 315, if the time difference between the video frame capture timestamp and the video frame capture target timestamp falls within the predetermined range of time values, then the video frame capture timestamp and the video frame is sent from the first device to a second device.

At operation 330, in one embodiment and as described herein, a subsequent video frame target timestamp associated with a subsequently captured video frame is updated. At operation 335, in one embodiment and as described herein, a subsequent video frame capture timestamp for a subsequently captured video frame is estimated, wherein the estimating is based on historical video frame capture data.

(2) Adaptive Video Frame Dropping Before Video Frame Encoding to Facilitate Packet Scheduling Control

Video encoding is the process of converting digital video files from one format to another. All of the videos watched on computers, tablets, mobile phones and set-top boxes must go through an encoding process to convert the original “source” video to be viewable on these devices. Encoding is necessary because different devices and browsers support different video formats. This process is also sometimes called “transcoding” or “video conversion.”

The different formats of the digital video may have specific variables such as containers (e.g., .MOV, .FLV, .MP4, .OGG, .WMV, WebM), codecs (e.g., H264, VP6, ProRes) and bit rates (e.g., in megabits or kilobits per second). The different devices and browsers have different specifications involving these variables.

A network quality of service (QoS) layer monitors the varying network conditions in terms of instant channel bandwidth, round trip time, jitter, packet loss, etc. Then, the network QoS layer feeds back the real time monitored information to the video encoder.

In order to maximize the packet sending throughout, leaky bucket mechanisms are introduced to schedule a packet to be pushed into the network whenever channel conditions allow for this. However, for real-time communications, video packets cannot be buffered without delay constraint. Upon experiencing network congestion, it is unavoidable to incur packet dropping to satisfy end-to-end delay constraints and also to give away the limited channel bandwidth to packets of higher priority such as control packets or audio packets.

Due to the nature of video encoding, the dropping of video packets may require the encoding of a synchronized video frame in order to resume video flow, if the dropped video packet is part of a video frame to be used as a reference.

A frame is a complete image captured during a known time interval, and a field is the set of odd-numbered or even-numbered scanning lines composing a partial image. When video is sent in interlaced-scan format, each frame is sent as the field of odd-numbered lines followed by the field of even-numbered lines.

Frames that are used as a reference for predicting other frames are referred to as reference frames. There are at least three types of pictures (or reference frames) used in video compression: I-frames, P-frames, and B-frames. In such designs, the frames that are coded without prediction from other frames are called the I-frames, frames that use prediction from a single reference frame (or a single frame for prediction of each region) are called P-frames, and frames that use a prediction signal that is formed as a (possibly weighted) average of two reference frames are called B-frames.

An I-frame is an ‘Intra-coded picture’, in effect a fully specified picture, like a conventional static image file. P-frames and B-frames hold only part of the image information, so they need less space to store than an I-frame, and thus improve video compression rates.

A P-frame (‘Predicted picture’) holds only the changes in the image from the previous frame. For example, in a scene where a car moves across a stationary background, only the car's movements need to be encoded. The encoder does not need to store the unchanging background pixels in the P-frame, thus saving space. P-frames are also known as delta-frames.

A B-frame (‘Bi-predictive picture’) saves even more space by using differences between the current frame and both the preceding and following frames to specify its content.

A synchronized video frame is either an I/IDR frame of a P frame that uses an acknowledged reference video frame. This synchronized video frame is independent of the encoding of previous encoded video frames and can stop error propagation incurred by previous video packet dropping. Such synchronized video frames, especially IDR frames, usually incur large video frame size. This large video frame size consumes more bandwidth, adding burden to the already possibly bad network conditions, as well as creating a challenge to deliver such a large video frame size in its full completeness. If any video packet of such a large video frame is being dropped, another synchronized video frame has to be inserted.

Embodiments provide for video frame dropping before encoding occurs, the video frame dropping facilitated by video packet scheduling, and thereby avoids the insertion of a synchronized video frame of a large video frame size. More particularly, embodiments provide for a video packet scheduling control mechanism that incorporates adaptive frame dropping before encoding occurs. A video packet is a formatted unit of video data carried by the computer network. If the video encoder in the media layer is aware of the status of the video packet scheduling details from the computer network layer, the video encoder proactively drops video frames before encoding, thereby avoiding unnecessary later packet dropping after encoding occurs. Since the dropping of one video frame before encoding is independent of the encoding of other video frames, it can effectively avoid the insertion of synchronized video frames of a large size.

Feedback information regarding the packet scheduling details may be communicated, and a transmission buffer may be implemented before encoding. The transmission buffer, instead of real video frame buffering, is used to facilitate the decision regarding video frame dropping. The transmission buffer size may be determined by the target bit rate multiplied by the time window to constrain the average encoding bit rate. The transmission buffer fullness of the transmission buffer is increased by the encoded video frame bits and reduced by the real time transmission bit rate.

To facilitate video packet scheduling, the transmission buffer fullness is further constrained by the packet scheduling buffer status in the computer network layer. For instance, if the video packet scheduling buffer indicates that it is close to having to drop at least one packet due to network congestion, the transmission buffer shall increase its fullness such that no sufficient buffer space is left for the encoding of upcoming new video frames, which results in appropriate video frame dropping.

Further benefits of embodiments include, as a result of dropping a video frame before encoding that is destined to be dropped, CPU time is saved. Historical data is used to more precisely predict the video frame size before encoding in order to more accurately predict whether an upcoming video frame should be dropped. For example, if the video frame size may be predicted based on different video frame types, such as an I frame or a P video frame type, an average of the most recent number of I video frame sizes and/or P video frame sizes may be used.

Thus, embodiments enable the avoidance of an overshoot. For example, when it is desired for an encoder to generate 100 k FPS, the encoder instead generates 200 k FPS, creating an encoder overshoot. If this 200 k FPS is sent to a router, the router would not transmit it because this would create too much network congestion. In one embodiment, a video frame is dropped inside of an encoding. For example, the encoder may have encoded a video frame, and then realized it is generating an encoder overshoot. The encoder may drop this video frame and then generate the next video frame. Basically, the encoder reverted to its previous state and tries to encode the next video frame. (This example is considered to be dropping inside the encoder.) Or the network could tell the pipeline to not send the video frame to the encoder at all.

FIG. 4 illustrates a video frame packet scheduling control mechanism 400 for proactively dropping video frames, in accordance with an embodiment. The video frame packet scheduling control mechanism 400 includes, as will be described below, the following components coupled with a computer: a video frame packet scheduling buffer accessor 415; a video frame packet scheduling buffer status receiver 420; and a transmission buffer fullness adjuster 425. In various embodiments and as will described herein, the video frame packet scheduling control mechanism 400 optionally includes, coupled with the computer, an upcoming video frame dropper 430 which optionally includes a video frame size predictor 435 and a video frame range of size value determiner 440.

The video frame packet scheduling buffer accessor 415 accesses a video frame packet scheduling buffer 405 in a computer network layer 450. The video frame packet scheduling buffer status receiver 420 receives a video frame packet scheduling buffer status of the video frame packet scheduling buffer 405. The video frame packet scheduling buffer status indicates that the video frame packet scheduling buffer 405 is close to dropping a video frame packet due to network congestion, wherein the video frame packet includes at least one video frame. The current traffic and/or the predicted traffic on the network are predicted to be more than the network can incur, thereby causing the message that a video frame packet is going to be dropped, given the situation of too much network congestion.

The transmission buffer fullness adjuster 425 increases a transmission buffer fullness of a transmission buffer 445 such that there is insufficient buffer space left in the transmission buffer 445 for encoding an upcoming video frame of the at least one video frame, such that the upcoming video frame is dropped before the encoding of a video frame of the at least one video frame occurs.

The upcoming video frame dropper 430 drops the upcoming video frame before encoding if there is insufficient room in the transmission buffer for the upcoming video frame. As mentioned herein, the upcoming video frame dropper 430 optionally includes the video frame size predictor 435 and the video frame range of size value determiner 440. The video frame size predictor 435 predicts a size of the upcoming video frame using historical video frame data, thereby achieving a predicted size of said upcoming video frame 455. The video frame range of size value determiner 440 determines if the predicted size of the upcoming video frame 455 falls outside of a predetermined range of size values.

FIG. 5 illustrates a flow diagram of method for proactively dropping of video frames. At operation 505, in one embodiment and as described herein, a video frame packet scheduling buffer in a computer network layer is accessed. At operation 510, in one embodiment and as described herein, a video frame packet scheduling buffer status of the video frame packet scheduling buffer is received, wherein the video frame packet scheduling buffer status indicates that the video frame packet scheduling buffer is close to dropping a video frame packet due to network congestion, wherein the video frame packet includes at least one video frame.

At operation 515, in one embodiment and as described herein, a transmission buffer fullness of a transmission buffer is increased such that there is insufficient buffer space left in the transmission buffer for encoding an upcoming video frame of the at least one video frame, such that the upcoming video frame is dropped before encoding a video frame of the at least one video frame occurs.

At operation 520, in one embodiment and as described herein, the upcoming video frame is dropped before encoding if there is insufficient room in the transmission buffer for the upcoming video frame. In one embodiment, the dropping at operation 520 includes: predicting a size of the upcoming video frame, using historical video frame data, to achieve a predicted size of the upcoming video frame; and if the predicted size of the upcoming video frame falls outside of a predetermined range of size values, then the upcoming video frame is dropped before the encoding occurs.

At operation 525, in one embodiment and as described herein, the upcoming video frame is sent for the encoding if there is sufficient room in the transmission buffer for the upcoming video frame. In one embodiment, the sending at operation 525 includes: predicting a size of the upcoming video frame, using historical video frame data, to achieve a predicted upcoming video frame size; and if the upcoming video frame size falls within a predetermined range of size values, then sending the upcoming video frame for the encoding.

(3) Dynamic Video Frame Dropping Before Video Frame Rendering

It is generally desirable to render video frames at approximately the same pace in which the video frames were captured. This results in the best possible subjective visual quality in the user's experience. However, the following aspects are largely varying in consecutive video frames: the end-to-end delay, including video pre-processing and/or post-processing, video encoding and/or video decoding, packet scheduling, network delay, etc.; and the device rendering capability. Without appropriate video frame rendering control, video frame jerkiness and/or unacceptable long delays may be observed upon video frame rendering, thereby causing an unsatisfactory video experience.

Embodiments use an adaptive video frame rendering scheduling paradigm to smooth out the jerkiness in video rendering and also to drop video frames adaptively to avoid an unacceptable end-to-end delay. The adaptive video frame rendering scheduling paradigm uses a video frame capture timestamp marked to every video frame and a video frame buffer between the video frame encoder and the video frame renderer. (A timestamp is attached to every video frame. Both this concept [Adaptive Video Frame Dropping/Pacing After Video Capturing] and the concept described below [Dynamic Video Frame Dropping Before Video Frame Rendering] are based on the timestamps attached to every video frame. When a video frame is played, the time stamp associated with that video frame has to match the time stamp associated with an audio frame, in order for the video and the audio to match up and enable a good viewing experience.)

In the adaptive video frame rendering scheduling paradigm, every video frame is associated with a timestamp at capturing (video frame capture timestamp). This video capture timestamp is stored throughout the entire video frame processing pipeline until the video frames are rendered.

The video frame capture timestamp is used to schedule the target video frame rendering time schedule according to the following rules: (1) video frames shall be rendered immediately if the video frames are late for their schedule; (2) video frames should be placed on hold with an adjusted delay if the video frames are earlier than their schedule; (3) video frames should be dropped if they are too late for their schedule, but the dropping shall not incur buffer underflow (i.e., video frames are dropped only when there is still frame buffered).

The above target video frame rendering time schedule is determined by comparing the time difference between the following two time intervals: (1) the time interval between the timestamp associated with the current video frame being considered and the timestamp of the very first captured video frame (i.e., the starting video frame capturing time instance); and (2) the time interval between the time instance that the current video frame being considered for rendering and the starting video frame rendering time instance.

The starting video frame rendering time instance is adjusted automatically over time and updated by the most recent target video frame rendering time schedule. This adjusting and updating occur according to the following rule: whenever a video frame is being rendered, its final video frame rendering schedule is considered as in line with its original video frame capturing schedule.

Embodiments involving the dynamic frame dropping before rendering only work with mobile devices.

If 10 FPS are sent to the second device (e.g., receiver) but the video frame renderer can only handle the load of 5 FPS. If the renderer is forced to generate 10 FPS, a large latency will occur and the audio and the video will be out of sync.

FIG. 6 illustrates a device 605 for proactive video frame dropping, in accordance with embodiments. The device 605 includes, as will be described below, the following components coupled with a computer: a video frame capture timestamp recorder 620; a video frame capture timestamp associator 625; a time difference comparor 640; and a target video frame rendering time instance scheduler 655.

The video frame capture timestamp recorder 620 records a video frame capture timestamp 615 for a video frame 610 that is captured first at a first device 600. In other words, the first video frame that is captured at the first device 600 is that for which the video frame capture timestamp 615 is recorded.

The video frame capture timestamp associator 625 associates the video frame capture timestamp 615 to the video frame 610 that is captured first

The time difference comparor 540 compares a time difference between a first time interval and a second time interval. The first time interval 645 is a first time difference between a timestamp associated with a current video frame being considered for rendering and a timestamp of the video frame that is captured first. The second time interval 650 is a second time difference between a time instance of the current video frame being considered for rendering and a starting video frame rendering time instance of the video frame that is captured first.

The target video frame rendering time instance scheduler 655 schedules a target video frame rendering time instance of the current video frame being considered for rendering according to a set of video frame rendering rules 660. The set of video frame rendering rules 660 includes rule 665, maintaining a target video frame rendering time schedule in which the second interval is maintained in proportion to the first time interval.

The set of video frame rendering rules 660 further includes: rule 670, at least one video frame shall be rendered immediately if the at least one video frame is late for its schedule; rule 675, at least one video frame shall be placed on hold with an adjusted delay if it is earlier than its schedule; and rule 680, at least one video frame shall be dropped if it is too late for its schedule, wherein a dropping of the at least one video frame shall not incur transmission buffer underflow.

FIG. 7 illustrates a flow diagram of a method for proactively dropping video frames, in accordance with embodiments. At operation 705, in one embodiment and as described herein, a video frame capture timestamp for a video frame that is captured first at a first device is recorded. At operation 710, in one embodiment and as described herein, the video frame capture timestamp is associated to the video frame that is captured first. At operation 715, in one embodiment and as described herein, a time difference between a first time interval and a second time interval is compared. The first time interval is a first time difference between a timestamp associated with a current video frame being considered for rendering and a timestamp of the video frame that is captured first. The second time interval is a second time difference between a time instance of the current video frame being considered for rendering and a starting video frame rendering time instance of the video frame that is captured first.

At operation 720, in one embodiment and as described herein, the target video frame rendering time instance of the current video frame being considered for rendering is scheduled according to a set of video frame rendering rules. The set of video frame rendering rules includes maintaining a target video frame rendering time schedule in which the second interval is maintained in proportion to the first time interval.

In various embodiments, methods 300, 500, and 700 are carried out by processors and electrical components under the control of computer readable and computer executable instructions. The computer readable and computer executable instructions reside, for example, in a data storage medium such as computer usable volatile and non-volatile memory. However, the computer readable and computer executable instructions may reside in any type of computer readable storage medium. In some embodiments, methods 300, 500, and 700 are performed by devices 800 and/or device 900, and more particularly, by device 202, video frame packet scheduling control mechanism 410, and/or device 605, as described in FIGS. 2-10.

FIGS. 8 and 9 depict devices 800 and 900 participating in a video conference. In general, video conferencing allows two or more locations to interact via multi-way video and audio transmissions simultaneously.

Of note, the device 202, the video frame packet scheduling control mechanism 410, and/or the device 605 are coupled with and function within a mobile device. In one embodiment, the mobile device includes the components that are described in the device 800 in FIG. 10. The functionality of the device 800 during a video conference between devices 800 and 900 is described below with reference to FIGS. 8 and 9.

Devices 800 and 900 are any communication devices (e.g., laptop, desktop, smartphones, tablets, TV, etc.) capable of participating in a video conference. In various embodiments, device 900 is a hand-held mobile device, such as smart phone, personal digital assistant (PDA), and the like.

Moreover, for clarity and brevity, the discussion will focus on the components and functionality of device 800. However, device 900 operates in a similar fashion as device 800. In one embodiment, device 900 is the same as device 800 and includes the same components as device 800.

In one embodiment, device 800 is variously coupled with any of the following, as described herein: device 202, video packet scheduling control mechanism 410, and device 605, in various embodiments. Device 800 and/or device 202, video packet scheduling control mechanism 410, and/or device 605 are further coupled with, in various embodiments, the following components: a display 1010; a transmitter 1040; a video camera 1050; a microphone 1052; a speaker 1054; an instruction store 1025; and a global positioning system 1060, as is illustrated in FIG. 10, a block diagram of the device 800, according to an embodiment.

Display 810 is configured for displaying video captured at device 900. In another embodiment, display 810 is further configured for displaying video captured at device 800.

Transmitter 840 is for transmitting data (e.g., control code).

The video camera 850 captures video at device 800. The microphone 852 captures audio at device 800. The speaker 854 generates an audible signal at device 800.

The global positioning system 860 determines a location of a device 800.

Referring now to FIGS. 8A and 8B, devices 800 and 900 are participating in a video conference with one another, in accordance with an embodiment. In various embodiments, more than two devices participate in a video conference with each another.

During the video conference, video camera 950 captures video at device 900. For example, video camera 950 captures video of user 905 of device 900.

Video camera 850 captures video at device 800. For example, video camera 850 captures video of user 805. It should be appreciated that video cameras 850 and 950 can capture any objects that are within the respective viewing ranges of cameras 850 and 950. (See discussion below with reference to FIG. 9.)

Microphone 852 captures audio signals corresponding to the captured video signal at device 800. Similarly, a microphone of device 900 captures audio signals corresponding to the captured video signal at device 900.

In one embodiment, the video captured at device 900 is transmitted to and displayed on display 810 of device 800. For example, a video of user 905 is displayed on a first view 812 of display 810. Moreover, the video of user 905 is displayed on a second view 914 of display 910.

The video captured at device 800 is transmitted to and displayed on display 910 of device 900. For example, a video of user 805 is displayed on first view 912 of display 910. Moreover, the video of user 805 is displayed on a second view 814 of display 810.

In one embodiment, the audio signals captured at devices 800 and 900 are incorporated into the captured video. In another embodiment, the audio signals are transmitted separate from the transmitted video.

As depicted, first view 812 is the primary view displayed on display 810 and second view 814 is the smaller secondary view displayed on display 810. In various embodiments, the size of both the first view 812 and the second view 814 are adjustable. For example, the second view 814 can be enlarged to be the primary view and the first view 112 can be diminished in size to be the secondary view (second view 814). Moreover, either one of views, first view 812 and second view 814 can be closed or fully diminished such that it is not viewable.

With reference now to FIG. 9, the user 905 of device 900 is capturing the image of a bridge 960 (instead of capturing an image of himself/herself 905), which is within the viewing range of video camera 950. The image of the bridge is depicted at second view 914 of device 900, and at a first view 812 of device 800.

All statements herein reciting principles, aspects, and embodiments of the technology as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present technology, therefore, is not intended to be limited to the embodiments shown and described herein. Rather, the scope and spirit of present technology is embodied by the appended claims.

1. A non-transitory computer readable storage medium having stored thereon, computer-executable instructions that, when executed by a computer, cause said computer to perform a method for proactively dropping video frames, wherein said method comprises:
recording, by said computer, a video frame capture timestamp for a video frame that is captured at a first device;
associating, by said computer, said video frame capture timestamp to said video frame that is captured;
comparing, by said computer, said video frame capture timestamp with a video frame capture target timestamp for said video frame; and
based on said comparing, if a time difference between said video frame capture timestamp and said video frame capture target timestamp is outside of a predetermined range of time values, then dropping, by said computer, said video frame.

2. The non-transitory computer readable storage medium of claim 1, wherein said method further comprises:
based on said comparing, if said time difference between said video frame capture timestamp and said video frame capture target timestamp falls within said predetermined range of time values, then sending, by said computer, said video frame capture timestamp and said video frame from said first device to a second device.

3. The non-transitory computer readable storage medium of claim 1, wherein said method further comprises:
updating, by said computer, a subsequent video frame target timestamp associated with a subsequently captured video frame.

4. The non-transitory computer readable storage medium of claim 1, wherein said method further comprises:
estimating, by said computer, a subsequent video frame capture timestamp for a subsequently captured video frame, wherein said estimating is based on historical video frame capture data.

5. A device for proactively dropping video frames, said device comprising:
a video frame capture timestamp recorder coupled with a computer, said video frame capture timestamp recorder configured for recording a video frame capture timestamp for a video frame that is captured at a first device;
a video frame capture timestamp associator coupled with said computer, said video frame capture timestamp associator configured for associating said video frame capture timestamp to said video frame that is captured;
a video frame capture timestamp comparor coupled with said computer, said video frame capture timestamp comparor configured for comparing said video frame capture timestamp with a video frame target timestamp for said video frame; and
a video frame manipulator coupled with said computer, said video frame manipulator configured for manipulating said video frame depending on a time difference between said video frame capture timestamp and said video frame target timestamp, said video frame manipulator comprising:
a video frame dropper configured for, if said time difference between said video frame capture timestamp and said video frame target timestamp is outside of a predetermined range of values, then dropping said video frame.

6. The device of claim 5, wherein said video frame information sender further comprises:
a video frame sender configured for, based on said comparing, if said time difference between said video frame capture timestamp and said video frame target timestamp falls within said predetermined range of values, then sending said video frame capture timestamp and said video frame from said first device to a second device.

7. The device of claim 5, further comprising:
a video frame target timestamp updater coupled with said computer, said video frame target timestamp updater configured for updating a subsequent video frame target timestamp associated with a subsequently captured video frame.

8. The device of claim 5, further comprising:
a video frame capture timestamp estimator coupled with said computer, said video frame capture timestamp estimator configured for estimating a subsequent video frame capture timestamp for a subsequently captured video frame, wherein said estimating is based on historical video frame capture data.

9. A non-transitory computer readable storage medium having stored thereon, computer-executable instructions that, when executed by a computer, cause said computer to perform a method for proactively dropping video frames, wherein said method comprises:
accessing, by said computer, a video frame packet scheduling buffer in a computer network layer;
receiving, by said computer, a video frame packet scheduling buffer status of said video frame packet scheduling buffer, wherein said video frame packet scheduling buffer status indicates that said video frame packet scheduling buffer is close to dropping a video frame packet due to network congestion, wherein said video frame packet comprises at least one video frame;
increasing, by said computer, a transmission buffer fullness of a transmission buffer such that there is insufficient buffer space left in said transmission buffer for encoding an upcoming video frame of said at least one video frame, such that said upcoming video frame is dropped before encoding a video frame of said at least one video frame occurs.

10. The non-transitory computer readable storage medium of claim 9, wherein said method further comprises:
dropping, by said computer, said upcoming video frame before encoding if there is insufficient room in said transmission buffer for said upcoming video frame.

11. The non-transitory computer readable storage medium of claim 10, wherein said dropping, by said computer, said upcoming video frame before encoding comprises:
predicting a size of said upcoming video frame, using historical video frame data, to achieve a predicted size of said upcoming video frame; and
if said predicted size of said upcoming video frame falls outside of a predetermined range of size values, then dropping said upcoming video frame before said encoding occurs.

12. The non-transitory computer readable storage medium of claim 9, wherein said method further comprises:
sending, by said computer, said upcoming video frame for said encoding if there is sufficient room in said transmission buffer for said upcoming video frame.

13. The non-transitory computer readable storage medium of claim 12, wherein said sending, by said computer, said upcoming video frame for said encoding comprises:
predicting a size of said upcoming video frame, using historical video frame data, to achieve a predicted upcoming video frame size; and
if said upcoming video frame predicted size falls within a predetermined range of size values, then sending said upcoming video frame for said encoding.

14. A video frame packet scheduling control mechanism for proactively dropping video frames, said video frame packet scheduling control mechanism comprising:
a video frame packet scheduling buffer accessor, coupled with a computer, said video frame packet scheduling buffer accessor configured for accessing a video frame packet scheduling buffer in a computer network layer;
a video frame packet scheduling buffer status receiver coupled with said computer, said video frame packet scheduling buffer status receiver configured for receiving a video frame packet scheduling buffer status of said video frame packet scheduling buffer, wherein said video frame packet scheduling buffer status indicates that said video frame packet scheduling buffer is close to dropping a video frame packet due to network congestion, wherein said video frame packet comprises at least one video frame;
a transmission buffer fullness adjuster, coupled with said computer, said transmission buffer fullness adjuster configured for increasing a transmission buffer fullness of a transmission buffer such that there is insufficient buffer space left in said transmission buffer for encoding an upcoming video frame of said at least one video frame, such that said upcoming video frame is dropped before said encoding a video frame of said at least one video frame occurs.

15. The video frame packet scheduling control mechanism of claim 14, further comprising:
an upcoming video frame dropper, coupled with said computer, said upcoming video frame dropper configured for dropping said upcoming video frame before encoding if there is insufficient room in said transmission buffer for said upcoming video frame.

16. The video frame packet scheduling control mechanism of claim 15, wherein said upcoming video frame dropper comprises:
a video frame size predictor configured for predicting a size of said upcoming video frame, using historical video frame data, to achieve a predicted size of said upcoming video frame; and
a video frame range of size value determiner configured for determining if said predicted size falls outside of a predetermined range of size values.

17. A non-transitory computer readable storage medium having stored thereon, computer-executable instructions that, when executed by a computer, cause said computer to perform a method for proactively dropping video frames, wherein said method comprises:
recording a video frame capture timestamp for a video frame that is captured first at a first device;
associating said video frame capture timestamp to said video frame that is captured first;
comparing a time difference between a first time interval and a second time interval, said first time interval being a first time difference between a timestamp associated with a current video frame being considered for rendering and a timestamp of said video frame that is captured first, said second time interval being a second time difference between a time instance of said current video frame being considered for rendering and a starting video frame rendering time instance of said video frame that is captured first; and
scheduling a target video frame rendering time instance of said current video frame being considered for rendering according to a set of video frame rendering rules, wherein said set of video frame rendering rules comprises:
maintaining a target video frame rendering time schedule in which said second interval is maintained in proportion to said first time interval.

18. A device for proactively dropping video frames comprising:
a video frame capture timestamp recorder coupled with a computer, said video frame capture timestamp recorder configured for recording a video frame capture timestamp for a video frame that is captured first at a first device;
a video frame capture timestamp associator coupled with said computer, said video frame capture timestamp associator configured for associating said video frame capture timestamp to said video frame that is captured first;
a time difference comparor coupled with said computer, said time difference comparor configured for comparing a time difference between a first time interval and a second time interval, said first time interval being a first time difference between a timestamp associated with a current video frame being considered for rendering and a timestamp of said video frame that is captured first, said second time interval being a second time difference between a time instance of said current video frame being considered for rendering and a starting video frame rendering time instance of said video frame that is captured first; and
a target video frame rendering time instance scheduler coupled with said computer, said target video frame rendering time instance scheduler configured for scheduling a target video frame rendering time instance of said current video frame being considered for rendering according to a set of video frame rendering rules, wherein said set of video frame rendering rules comprises:
maintaining a target video frame rendering time schedule in which said second interval is maintained in proportion to said first time interval.

19. The device of claim 18, wherein said video frame rendering rules comprises:
at least one video frame shall be rendered immediately if said at least one video frame is late for its schedule.

20. The device of claim 18, wherein said video frame rendering rules comprises:
at least one video frame shall be placed on hold with an adjusted delay if it is earlier than its schedule.

21. The device of claim 18, wherein said video frame rendering rules comprises:
at least one video frame shall be dropped if it is too late for its schedule, wherein a dropping of said at least one video frame shall not incur transmission buffer underflow.
